(19) United States
(12) Patent Application Publication
(10) Pub. No.: US 2008/0236115 A1
(43) Pub. Date: Oct. 2, 2008

(54) HONEYCOMB FILTER AND EXHAUST GAS PURIFICATION DEVICE

(75) Inventor: Keiichi SAKASHITA, Gifu (JP)

Correspondence Address: DITTHAVONG MORI & STEINER, P.C., 918 Prince St., Alexandria, VA, 22314, US

(73) Assignee: IBIDEN CO., LTD., Ogaki (JP)

(21) Appl. No.: 12/024,006

(22) Filed: Jan. 31, 2008

(30) Foreign Application Priority Data
Mar. 30, 2007 (JP) 2007-093854
Aug. 27, 2007 (JP) PCT/JP2007/066582

(51) Int. Cl. B01D 50/00; B01D 46/00

(52) U.S. Cl. 55/385.3; 55/484

(57) ABSTRACT

A honeycomb filter includes a pillar shape honeycomb structure that has a plurality of cells, which are arranged in a honeycomb shape and partitioned by cell walls, and a plug that seals either one of open ends of each cell. In the honeycomb filter, the plug has a shell that occupies a peripheral region near the cell wall and a core that occupies a central region including the central axis of the cell. The Young's modulus of the shell differs from the Young's modulus of the core.

### CROSS-REFERENCE TO RELATED APPLICATIONS

This application is based upon and claims the benefit of priority from prior Japanese Patent Application No. 2007-93854, filed on Mar. 30, 2007, and International Patent Application No. PCT/JP2007/066582, filed on Aug. 27, 2007. The contents of the prior applications are incorporated herein by reference.

### BACKGROUND OF THE INVENTION

1. Field of the Invention

This disclosure relates to a honeycomb filter and an exhaust gas purification device.

2. Discussion of the Background

In recent years, for environmental protection, the demand for removing particulate matter (PM) or the like from exhaust gases discharged from an internal combustion engine, a boiler or the like has increased. In particular, regulations relating to the removal of graphite particulates (hereafter referred to as PM) that are discharged from diesel engines have become stricter in Europe, the United States, and Japan. A honeycomb filter having a honeycomb structure and referred to as a diesel particulate filter (DPF) has been used to capture and remove PM. A honeycomb filter is accommodated in a casing that is arranged in an exhaust pipe. The honeycomb filter includes a large number of cells, which extend longitudinally through the filter. The cells are partitioned by cell walls. In each pair of adjacent cells, one cell has an end closed by a plug at one side and the other cell has an end closed by a plug at the opposite side. This forms a honeycomb structure of which end surfaces (inlet side end surface and outlet side end surface) each have a checkerboard pattern in their entirety. In the honeycomb structure, exhaust gas enters the cells that are open at the inlet side end surface, that is, the cells that are sealed at the outlet side end surface of the honeycomb structure. The exhaust gas then passes through the cell walls that are porous to be discharged from the adjacent cells that are sealed at the inlet side end surface, that is, open at the outlet side end surface. In this state, the cell walls function as a filter that captures, PM discharged from, for example, a diesel engine. The PM captured in the cell walls is burned and removed by a heating means, such as a burner or a heater, or by the heat of exhaust gas. In this the way, the filter is regenerated.

JP2002-210723A describes an example of a honeycomb filter known in the prior art. The honeycomb filter of JP2002-210723A describes filling cell ends of a honeycomb structure with a plug paste, the main component of which is ceramic particles, and drying or firing the plug paste to form a plug.

JP2004-168030 A describes a method for forming a honeycomb filter by generally molding a plug in correspondence with the cross-sectional shape of the cells in a honeycomb structure and arranging the plug in each cell. Then, a bonding agent is used to fill gaps formed between the plug and the cell. The main component of the bonding agent is the same as the main component of at least either one of the honeycomb structure and the plug to improve adhesiveness of the bonding agent.

The contents of JP2002-210723A and JP2004-168030A are incorporated herein by reference.

### SUMMARY OF THE INVENTION

One aspect of the present invention is a honeycomb filter including a pillar shape honeycomb structure, which has a plurality of cells partitioned by cell walls and arranged in a honeycomb shape, and a plug for sealing a selected one of open ends of each cell. The plug includes, in the open end of the corresponding cell, a shell (which is also referred to as a “clad”) that occupies a peripheral region of the corresponding cell and a core that occupies a central region of the corresponding cell, the central region including a central axis of the corresponding cell. The Young's modulus of the core differs from that of the shell.

Another aspect of the present invention is an exhaust gas purification device including a casing, a honeycomb filter accommodated in the casing, and a heat insulator arranged between an inner surface of the casing and an outer surface of the honeycomb filter. The honeycomb filter including a pillar shape honeycomb structure, which has a plurality of cells partitioned by cell walls and arranged in a honeycomb shape, and a plug for sealing a selected one of open ends of each cell. The plug includes, in the open end of the corresponding cell, a shell that occupies a peripheral region of the corresponding cell and a core that occupies a central region of the corresponding cell, the central region including a central axis of the corresponding cell. The Young's modulus of the core differs from the Young's modulus of the shell.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic view showing an exhaust gas purification device;

FIG. 2 is a cross-sectional view showing a honeycomb filter according to a preferred embodiment of the present invention;

FIG. 3 is a perspective view showing a honeycomb member;

FIG. 4 is an enlarged cross-sectional view showing a honeycomb filter in a casing;

FIG. 5(a) is an enlarged cross-sectional view of a plug taken along line B-B in FIG. 5(b), and FIG. 5(b) is an enlarged cross-sectional view of the plug taken along line A-A in FIG. 5(a);

FIGS. 6(a) and 6(b) are enlarged cross-sectional views showing a method for forming a plug by performing pillar shaped member insertion, with FIG. 6(a) showing a process of filling a plug paste P1 for a shell and FIG. 6(b) shows a process of inserting a pillar shaped member;

FIG. 7 is an enlarged cross-sectional view showing a method for forming a plug by performing two-color extrusion;

FIG. 8 is an enlarged cross-sectional view showing a honeycomb filter according to another embodiment of the present invention; and

FIG. 9 is a graph showing the relationship between the core area ratio and the maximum stress in examples and comparative examples.

### DETAILED DESCRIPTION

One embodiment of the present invention provides a honeycomb filter including a pillar shape honeycomb structure, which has a plurality of cells partitioned by cell walls and arranged in a honeycomb shape, and a plug for sealing a selected one of open ends of each cell. The honeycomb filter is characterized by a plug including, in the open end of the corresponding cell, a shell that occupies a peripheral region of the corresponding cell and a core that occupies a central region of the corresponding cell, the central region including a central axis of the corresponding cell, wherein the Young's modulus of the core differs from that of the shell.

In JP2002-210723A, the structure is normally vibrated after filling cell ends with plug paste in order to uniformly fill cell ends with the plug paste and improve adhesiveness of the plug paste to the walls of the cells. However, cracks may easily occur in the honeycomb filter described in JP2002-210723A, and the plug and adjacent cell walls may crack if thermal stress increases when the vehicle is being used or when burning and removing PM to regenerate the filter. If the plug porosity is increased to increase the plug elasticity and reduce such stress, the thermal resistance or strength, such as impact resistance, of the plug may be lowered.

The honeycomb filter described in JP2004-168030A is still insufficient from the viewpoint of crack prevention at the interface between the plug and cell.

One embodiment of the present invention has been made based on an observation that stress generated at the interface between the honeycomb structure (cell wall) and plug is reduced when materials having different physical properties are used for the plug at a core, which is located at the central region of a corresponding cell, and a shell, which is located at the peripheral region of the corresponding cell. Thus, the embodiment of the present invention advantageously reduces thermal stress generated at the interface between the plug and cell wall in a honeycomb filter.

A honeycomb filter according to a preferred embodiment of the present invention will now be discussed. The honeycomb filter is applicable for an exhaust gas purification device for a vehicle.

The exhaust gas purification device will first be discussed. In the present embodiment, the exhaust gas purification device is of a spontaneous ignition form in which the captured PM is burned and removed by the heat of exhaust gas to regenerate the honeycomb filter. However, the honeycomb filter is not limited to be used in an spontaneous ignition form exhaust gas purification device and PM processing may be performed in any manner.

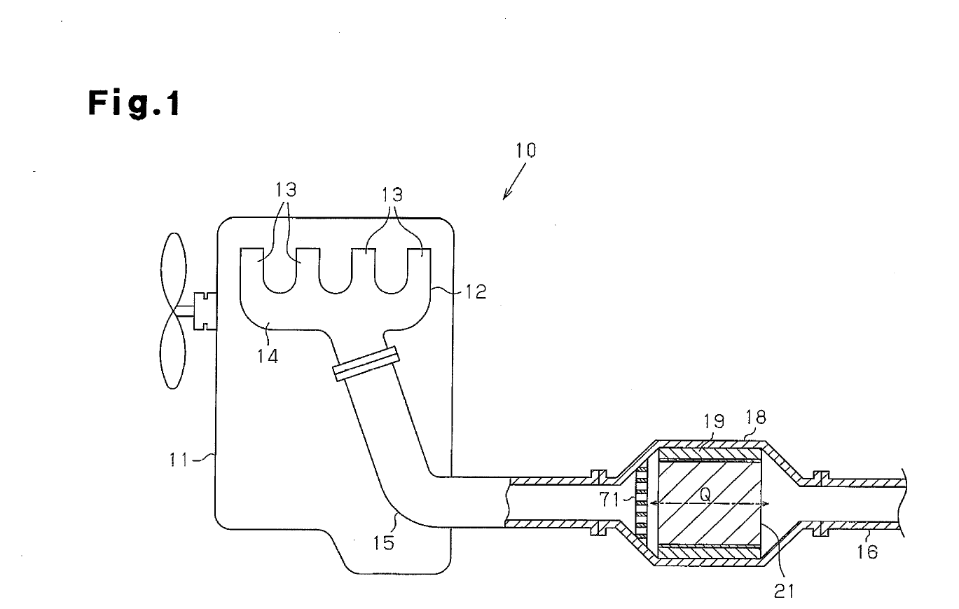

As shown in FIG. 1, an exhaust gas purification device 10 purifies, for example, exhaust gas discharged from a diesel engine 11. The diesel engine 11 includes a plurality of cylinders (not shown). An exhaust manifold 12, which includes a metal material, is connected to the cylinders by a plurality of branching portions 13. The branching portions 13 are connected to a single manifold body 14. Accordingly, exhaust gas discharged from the cylinders is concentrated at a single location.

A first exhaust pipe 15 and a second exhaust pipe 16, which include metal materials, are arranged at positions downstream from the exhaust manifold 12. The first exhaust pipe 15 has an upstream end connected to the manifold body 14. A tubular casing 18, which includes a metal material, is arranged between the first exhaust pipe 15 and the second exhaust pipe 16. The casing 18 has an upstream end connected to a downstream end of the first exhaust pipe 15 and a downstream end connected to an upstream end of the second exhaust pipe 16. As a result, the first exhaust pipe 15, the casing 18, and the second exhaust pipe 16 have internal regions in fluid communication, and exhaust gas flows through the internal regions of the first exhaust pipe 15, the casing 18, and the second exhaust pipe 16.

The casing 18 has a middle portion having a diameter that is larger than that of the exhaust pipes 15 and 16. Accordingly, the casing 18 has a larger inner area than the exhaust pipes 15 and 16. A honeycomb filter 21 is accommodated in the casing 18. A heat insulator 19 (holding sealing material), which is separate from the honeycomb filter 21, is arranged between the outer surface of the honeycomb filter 21 and the inner surface of the casing 18. A catalytic converter 71 is accommodated in the casing 18 upstream from the honeycomb filter 21. The catalytic converter 71 carries an oxidation catalyst, which is known in the art. The catalytic converter 71 oxidizes exhaust gas. Oxidation heat generated during the oxidation is transmitted into the honeycomb filter 21 to process PM in the honeycomb filter 21 (filter regeneration).

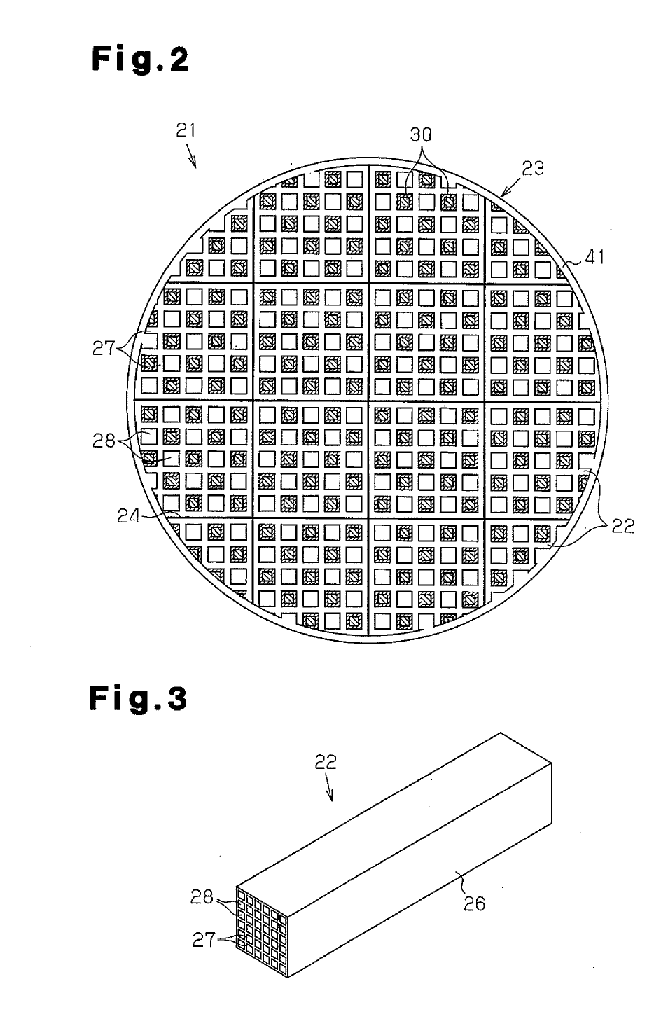

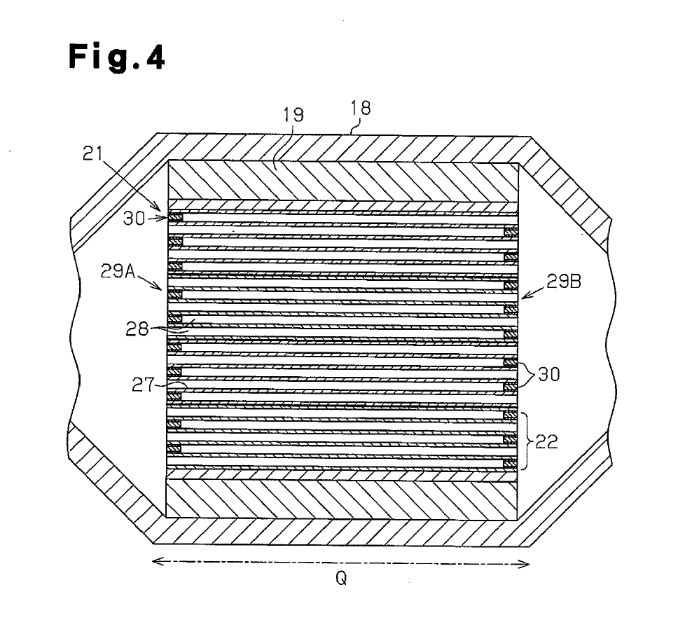

As shown in FIG. 2, the honeycomb filter 21 includes a cylindrical shape honeycomb structure 23 and plugs 30. The honeycomb structure 23 includes a plurality of (e.g., sixteen) square pillar-shaped honeycomb members 22. The plugs 30 are formed at predetermined positions in the ends of the honeycomb structure 23. The honeycomb filter 21 of the present embodiment is formed by drying honeycomb molded bodies, which are shaped identically to the honeycomb member 22, under predetermined conditions. Predetermined positions on each end of the dried honeycomb molded bodies are sealed with plugs and then dried and fired under predetermined conditions. A plurality of honeycomb fired bodies are bonded together with a bonding agent 24 to form an aggregation body. The aggregation body is then dried under predetermined conditions. The outer surface of the obtained aggregation body is cut so that the aggregation body has a circular cross-section. A paste for forming a coating layer is applied to the outer surface and dried to form a coating layer 41. This completes the honeycomb filter 21. In this specification, the term “cross-section” refers to a cross-sectional plane that is orthogonal to an axis Q of the honeycomb filter 21 (refer to FIGS. 1 and 4). The bonding agent 24, which may contain an inorganic binder, an organic binder, inorganic fibers or the like, and may be a known composition.

As shown in FIG. 3, each honeycomb member 22 has a square cross-sectional shape (or a portion thereof, for the honeycomb members along an outer periphery of the honeycomb structure) and includes an outer wall 26 and cell walls 27 arranged inward from the outer wall 26. A material forming the outer wall 26 and the cell walls 27 of the honeycomb member 22, that is, the main material (main component) of the honeycomb structure 23, may be, for example, ceramic. The “main component” refers to a component that constitutes about 50 mass percent or more of all the components forming the honeycomb structure 23. It is preferable that the main component constitutes about 80% or more of the honeycomb structure 23.

Examples of such a ceramic include a nitride ceramic such as aluminum nitride, silicon nitride, boron nitride and titanium nitride; a carbide ceramic such as silicon carbide, zirconium carbide, titanium carbide, tantalum carbide and tungsten carbide; an oxide ceramic such as alumina, zirconia, cordierite, mullite, silica, titania and aluminum titanate; and the like. These different kinds of porous ceramic may be used solely. Alternatively, two or more of these different kinds of porous ceramic may be used in combination. Among these different kinds of ceramic, the use of silicon carbide, cordierite, or aluminum titanate is preferable due to their high thermal resistance and high impact resistance.

The material for the honeycomb structure 23 may contain impurities such as Al, Fe, B, Si, and free carbon. The cell walls 27 in the present embodiment may carry an oxidation catalyst formed by, for example, a metal element such as a platinum group element (e.g., Pt and the like), an alkali metal, an alkali earth metal and the like, their oxides or the like. When the cell walls 27 carry such an oxidation catalyst, the oxidation catalyst may easily lower the burning temperature of the PM captured on and in the cell walls 27. Further, the catalyst functions to convert harmful substances such as NOx to harmless substances.

A plurality of cells 28 (through-holes), which extend through the honeycomb member 22 in the longitudinal direction of the honeycomb member 22, are partitioned by cell walls 27 to form a honeycomb shape. Each cell 28 has a substantially square cross-section (refer to FIGS. 2 and 3). As shown in FIG. 4, each cell 28 is hollow and extends from one end surface (upstream end surface 29A) to another end surface (downstream end surface 29B) in the direction of the axis Q and functions as a flow passage for exhaust gas, which serves as a fluid. On one of the end surfaces (upstream end surface 29A and downstream end surface 29B), each cell 28 has an open end that is sealed by a plug 30. As a result, a plurality of plugs 30 are arranged to form a complete checkerboard pattern on each end surface (upstream end surface 29A and downstream end surface 29B). That is, about one half of the plurality of cells 28 are open at the upstream end surface 29A, and the remaining cells 28 are open at the downstream end surface 29B.

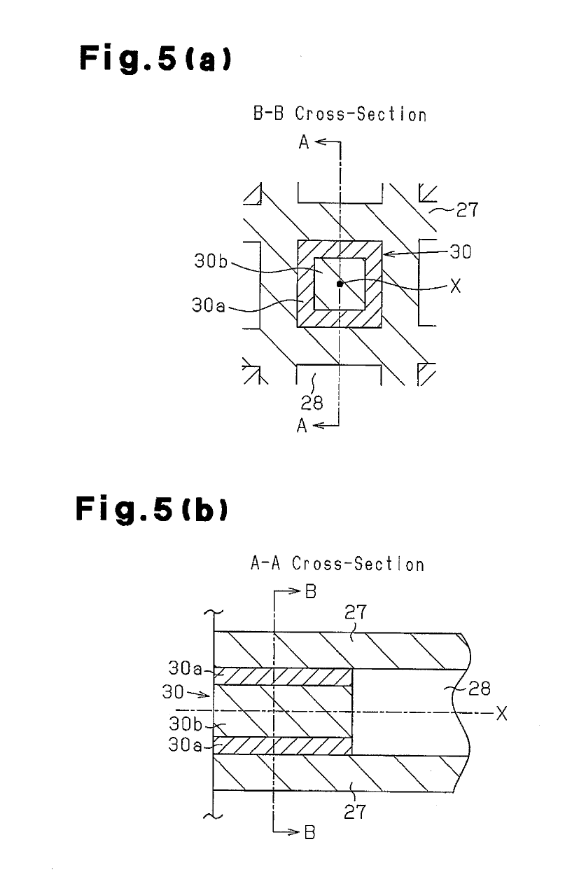

As shown in FIGS. 5(a) and 5(b), the plug 30 in each cell 28 has a dual structure including a shell 30a (first plug member) and a core 30b (second plug member). The shell 30a is adjacent to the corresponding cell wall 27 and occupies a peripheral region of the corresponding cell 28. The core 30b is not in contact with the corresponding cell wall 27 and occupies a central region of the corresponding cell 28. The central region includes a central axis X of the cell 28. The shell 30a has a Young's modulus (E) that differs from that of the core 30b. The difference in the Young's moduli (E) may easily suppress the stress generated at the interface between the plug 30 and the cell wall 27. Depending on the selection of the materials or material compositions of the shells 30a and the cores 30b enable the shells 30a and the cores 30b to have different Young's moduli (E). When formed from different ceramic materials, the shells 30a and the cores 30b usually have different Young's moduli. Even with the same material, the shells 30a and the cores 30b may have different Young's moduli when varying the porosity of the plug members. It is generally known that when the porosity of a ceramic material is increased, the Young's modulus decreases.

It is preferable that the main material (main component) of both the shells 30a and the cores 30b be the same ceramic as the material used for the honeycomb structure 23 so that the shells 30a and the cores 30b have the same properties as the honeycomb structure 23. Examples of such porous ceramic include nitride ceramic such as aluminum nitride, silicon nitride, boron nitride and titanium nitride; carbide ceramic such as silicon carbide, zirconium carbide, titanium carbide, tantalum carbide, and tungsten carbide; and oxide ceramic such as alumina, zirconia, cordierite, mullite, silica, titania, and aluminum titanate. The “main component” refers to a component constituting about 50 mass percent or more of the material for the plug 30.

The materials for the shells 30a and the cores 30b may contain impurities such as Al, Fe, B, Si, and free carbon in the same manner as the material for the honeycomb structure 23. The shells 30a and the cores 30b may have different Young's moduli (E) by appropriately selecting and adjusting the mixed amount of the above main materials (main component) and other components (impurities) or the like.

The Young's modulus (E), which is also referred to as a modulus of longitudinal elasticity, is a constant that determines the value of the strain relative to stress in an elasticity range. Based on the relationship between the strain amount and tensile stress or compressive stress in one direction, the Young's modulus (E) is calculated by dividing the stress (σ) by the strain (ε). The Young's modulus (E) that is used may be that known for each ceramic material (e.g., 430 GPa for silicon carbide (JIS R 1602)). Alternatively, the Young's modulus (E) of each ceramic material that is measured with a measurement device may be used. JIS R 1602 specifies the Young's modulus measurement method for ceramic materials under room temperature, and JIS R 1605 specifies the Young's modulus measurement method for ceramic materials under a high temperature.

The contents of JIS R 1602 and JIS R 1605 are incorporated herein by reference.

The Young's modulus varies depending on the temperature of the ceramic material. In the present embodiment, it is preferable that the Young's moduli of the shells 30a and the cores 30b differ under the usage temperature of the honeycomb filter (about 600 to about 800° C.). The Young's modulus may be measured using a known measurement method. For example, a strain gauge method, a stationary test method, a lateral vibration method, an ultrasonic method (pulse echo overlap method) or the like may be used to measure the Young's modulus.

The content amount of a foam material in the above material and water in the plug paste that becomes a raw material may be adjusted when varying the Young's modulus by changing the porosity of each of the shells 30a and the cores 30b. Any foam material may be used as long as the selected material can be decomposed by the heat generated during usage of the honeycomb filter. Known foam materials such as ammonium acid carbonate, ammonium carbonate, amyl acetate, butyl acetate, diazoaminobenzene and the like may be used as the foam material. Further, resins such as thermoplastic resin and thermosetting resin, inorganic balloons, organic balloons or the like may also be used as the foam material.

Any thermoplastic resin may be used. For example, acrylic resin, phenoxy resin, polyether sulfone, polysulphone and the like may be used. Any thermosetting resin may be used. For example, epoxy resin, phenolic plastic, polyimide resin, polyester resin, bismaleimide resin, polyolefin resin, polyphenylene ether resin and the like may be used. These resins may have any shape. For example, the resins may be spherical, oval, or cubic, or may have an indefinite massive shape, or may be pillar-shaped, plate-like or the like. When the resin has a spherical shape, it is preferred that the average particle diameter be about 30 to about 300 μm.

The balloons include bubbles and hollow spheres. Any organic balloon may be used. For example, acrylic balloons, polyester balloons or the like may be used. Any inorganic balloon may be used. For example, alumina balloons, glass micro balloons, silas balloons, fly ash (FA) balloons, mullite balloons and the like may be used. It is preferable that the shape, average particle diameter, and the like of the balloons be the same as the resins described above.

The Young's modulus (E) of the plug 30 may be controlled by containing foam material, resins such as thermoplastic resin or thermosetting resin, and organic or inorganic balloons in the plug 30 for the reasons described below. During the manufacturing stage of the honeycomb filter in the present embodiment, the above-described materials are substantially uniformly dispersed in the plugs. The honeycomb filter is heated to a high temperature during actual use of the honeycomb filter. This decomposes and burns away the organic components including the foam material and the like to form pores in the plug. In this state, the Young's modulus (E) of the plug 30 is controlled by adjusting the porosity, the pore diameter, and the like of the pores.

The Young's modulus of the core 30b, which occupies the central region of a cell, is preferably higher than the Young's modulus of the shell 30a, which occupies the peripheral region of the cell. This structure further reduces thermal stress generated at the interface between the plugs 30 and the cell walls 27. It is preferable that each core 30b occupy an area of about 20 to about 80% (hereafter referred to as an area ratio of the core) of the corresponding cell 28. More preferably, the area ratio of the core 30b is about 30 to about 70%, and still more preferably, about 40 to about 60%. When the area ratio of the core 30b is about 20% or more, the core 30b is not too small and is not difficult to manufacture. Further, since a shell 30a having a lower Young's modulus does not occupy a large part of the plug 30, the mechanical strength of the plug 30 is not lowered. When the difference in the Young's modulus between the cell walls 27 and the shell 30a is significantly large, the difference in the contraction rate between the cell walls 27 and the shells 30a increases accordingly. Thus, cracks are apt to be occurred in a drying process during manufacture of the honeycomb filter. When the area ratio of the core 30b is about 80% or less, the thermal stress generated at the interface between the plugs 30 and the cell walls 27 (refer to FIG. 9) would not increase. This may suppress cracking.

The Young's modulus of the shells 30a and that of the cores 30b are only required to be different and is not particularly limited. However, it is preferred that the shells 30a or the cores 30b having the higher Young's modulus have a Young's modulus of about 40 to about 60 GPa, and more preferably, about 50 to about 60 GPa. The shell 30a or the core 30b having a lower Young's modulus preferably has a Young's modulus of about 10 to about 40 GPa, and more preferably about 20 to about 35 GPa. When the Young's modulus of the plug 30 is 10 GPa or more, the mechanical strength may not be decreased. When the Young's modulus of the plug 30 is 60 GPa or less, resistance to rapid temperature change (impact resistance) of the plug 30 may not be decreased.

The shape of the cross-sectional plane of each core 30b orthogonal to the central axis X of the corresponding cell 28 is not particularly limited and may be polygonal such as substantially triangular, substantially tetragonal, substantially hexagonal, or substantially octagonal, or be substantially circular or the like. It is more preferable that the cross-sectional plane of the core 30b be substantially circular since thermal stress generated at the interface between the plugs 30 and the cell walls 27 is easily reduced.

As shown in FIG. 2, a coating layer 41 is formed on the entire outer surface of the honeycomb structure 23. The coating layer 41 prevents the honeycomb filter 21 from being displaced in the casing 18. The coating layer 41 contains inorganic particles, an inorganic binder, an organic binder and the like and may contain inorganic fibers.

A method for manufacturing the honeycomb filter 21 of the present embodiment will now be described. First, a method for manufacturing a honeycomb molded body that is shaped identically to the honeycomb member 22 will be described. The honeycomb molded body is formed by extruding a raw material paste containing ceramic particles (e.g. silicon carbide particles described above), which is the main raw material for the honeycomb molded body. The raw material paste may further contain a firing aid, such as aluminum, boron, iron and carbon; an organic binder (e.g. methylcellulose, carboxymethyl cellulose, hydroxyethyl cellulose, polyethyleneglycol and the like); water and the like. The “raw material paste” refers to a “raw material for forming the honeycomb structure 23” in this specification.

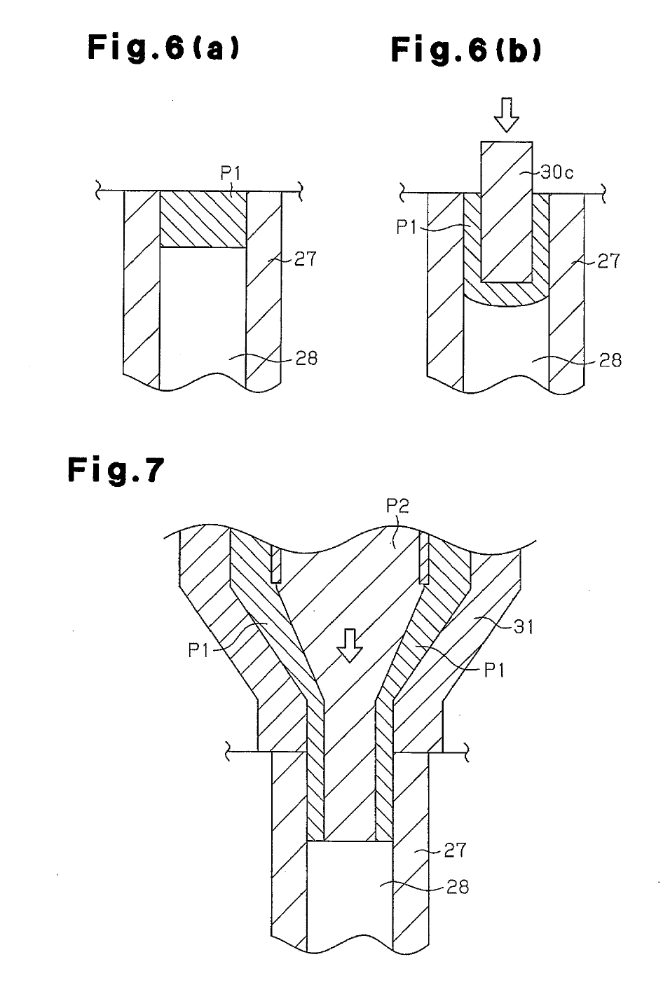

Next, open ends of predetermined cells 28 are sealed with the plugs 30. In detail, a shell 30a is arranged to occupy a peripheral region adjacent to the cell wall 27 of the corresponding cell 28, and a core 30b is arranged to occupy a central region of the cell 28. For example, as shown in FIGS. 6(a) and 6(b), a plug paste P1, which ultimately forms the shell 30a, is first filled in each cell 28 (refer to FIG. 6(a)), and then a pillar shaped member 30c, which forms the core 30b, is pressed into the plug paste P1 to form the plug 30 (refer to FIG. 6(b)). An appropriate known method, such as an extrusion method, using a mask having openings corresponding to the plug pattern, may be used to fill each cell 28 with the plug paste P1.

Alternatively, the plug paste P1 that ultimately forms the shell 30a and a plug paste P2 that ultimately forms the core 30b may be filled in each cell 28 by performing a two-color extrusion method using a two-color extrusion machine (or two-layer extrusion machine) 31 to fill the open end of each cell 28 as shown in FIG. 7. The plug pastes P1 and P2 may be formed mainly of ceramic particles (e.g. silicon carbide particles described above), and may additionally contain a firing aid, such as aluminum, boron, iron and carbon; a lubricant agent (e.g. polyoxyethylene mono butyl ether); a solvent (e.g. diethylene glycol mono-2-ethylhexyl ether); a dispersing agent (e.g. phosphate ester compound); a binder (e.g. methylcellulose, carboxymethyl cellulose, hydroxyethyl cellulose, polyethyleneglycol and the like) and the like. To control the porosity of the plug 30, the plug pastes P1 and P2 may further contain a foam material such as a thermoplastic resin, a thermosetting resin, inorganic balloons or organic balloons. The composition or the porosity of each of the plug pastes P1 and P2 is selected so that the shells 30a and the cores 30b have different Young's moduli. The pillar shaped members 30c may be prepared by molding the plug paste P2 into a predetermined shape and drying the plug paste P2.

The filter molded body, in which predetermined positions are filled with the plug paste, is dried, degreased, and fired under predetermined conditions to form a fired body. A plurality of fired bodies are bonded together with a bonding agent 24. The aggregation body is then dried under predetermined conditions and cut to have a circular cross-section. A coating layer 41 is then formed on the outer surface of the cut aggregation body. This completes the desired honeycomb filter 21.

The honeycomb filter 21 of the present embodiment has the advantages described below.

(1) The honeycomb filter 21 of the present embodiment includes the plugs 30, each of which is formed by the shell 30a that occupies the peripheral region of the corresponding cell 28 near the cell wall 27 and the core 30b that occupies the central region of the corresponding cell 28. The central region includes the central axis X of the corresponding cell 28. The shells 30a and the cores 30b have different Young's moduli. Accordingly, thermal stress generated at the interface between the plugs 30 and the cell walls 27 is easily suppressed. Further, cracks are easily prevented from occurring near the interface between the plugs 30 and the cell walls 27.

In particular, in a honeycomb filter that uses thin cell walls 27 to reduce the weight of the honeycomb filter and a honeycomb filter that uses cell walls 27 with a high porosity to prevent PM clogging, stress relaxation may suppress cracking of the cell walls 27 during usage (especially, PM processing (filter regeneration)).

(2) In the present embodiment, the Young's modulus of the core 30b, which occupies the central region of a cell, is higher than the Young's modulus of the shell 30a, which occupies the peripheral region of the cell. Accordingly, thermal stress is easily reduced and cracking is easily suppressed.

(3) In the present embodiment, it is preferred that each core 30b has a cross-section plane orthogonal to the central axis X of the plug 30 that is shaped to be substantially circular. This structure easily reduces thermal stress generated at the interface between the plugs 30 and the cell walls 27.

(4) In the present embodiment, it is preferred that the cell walls 27 carry an oxidation catalyst. In this case, it is easy to burn and remove the PM captured on and in the cell walls 27 by the catalytic action of the oxidation catalyst.

(5) In the present embodiment, the honeycomb structure 23 is formed by bonding a plurality of the honeycomb members 22 with the bonding agent 24. As compared with a honeycomb structure of another embodiment formed by a single honeycomb member 22, the honeycomb structure 23 of the present embodiment reduces thermal impact generated between the members of the honeycomb structure when PM is burned. This efficiently and effectively prevents cracking of the honeycomb structure 23.

The above embodiment may be modified in the following forms.

In the above embodiment, the open end of each cell 28 at one end of the honeycomb filter 21 (upstream end surface 29A or downstream end surface 29B) is sealed by the plug 30, which is formed by the shell 30a and the core 30b that have different Young's moduli. However, the plug 30 does not have to be formed by the shell 30a and the core 30b on both ends of the honeycomb filter 21 (upstream end surface 29A and downstream end surface 29B). It is only required that only one of the two ends of the honeycomb filter 21 include the plug 30 that is formed by the shell 30a and the core 30b.

In the above embodiment, some of the plugs may be replaced with conventional plugs as long as the advantages of the embodiment of the present invention are not affected. In other words, the plugs do not all have to be formed by the shells 30a and the cores 30b that have different Young's moduli.

In the above embodiment, it is preferred that the plugs 30, which are formed by the shells 30a and the cores 30b having different Young's moduli, be arranged at least at the downstream side of the cells 28. When the accumulating PM captured on the cell walls is burned and removed by a heating means such as a burner or a heater, or by the heat of exhaust gas, more heat load is applied to the downstream side of the honeycomb filter. Thus, such a structure easily prevents cracks from occurring at the downstream side of the honeycomb filter at which a large heat load is applied.

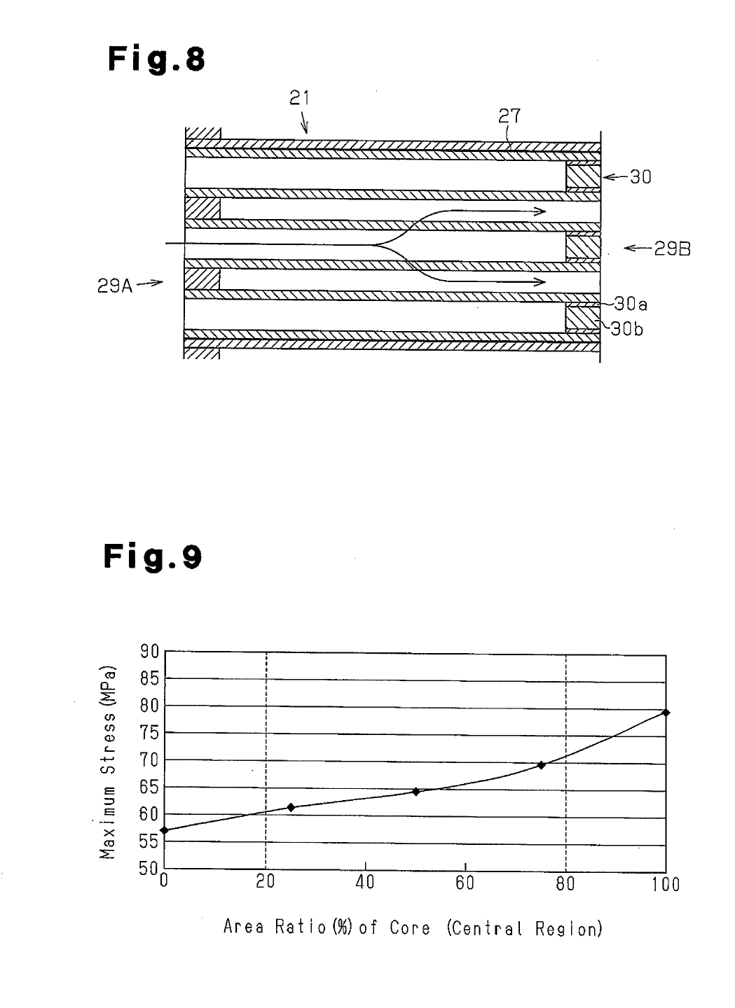

The honeycomb filter may include cells 28 having open ends at the upstream side and open ends at the downstream side with respect to the flow of exhaust gas having different cross-sectional areas, for example, by including cells 28 having large open ends on the upstream side (upstream end surface 29A) through which exhaust gas enters and cells 28 having small open ends on the downstream side (downstream end surface 29B) through which exhaust gas is discharged, as shown in FIG. 8. In this case, a greater area usually increases the degree of expansion and contraction. Thus, it is preferred that at least the open ends of cells 28 with the larger cross-sectional areas (the downstream end surface 29B) be sealed by the plugs 30 that are formed by the shells 30a and the cores 30b having mutual different Young's moduli. In this case, the open ends of cells 28 with the smaller cross-sectional areas (the upstream end surface 29A) may be sealed by plugs not having a core-shell structure.

In the above embodiment, the plurality of honeycomb members 22 are bonded together and the outer surface is cut to form the cylindrical shape honeycomb filter. Instead of this procedure, a plurality of honeycomb members having predetermined shapes in accordance with the shape of the honeycomb filter may be formed in advance, and these honeycomb members may be bonded together to form the cylindrical shape honeycomb filter. This eliminates the process of cutting the outer surface.

In the above embodiment, the plurality of honeycomb members 22 are bonded to form the honeycomb filter 21 (separated type). Alternatively, a single honeycomb member may form the honeycomb filter (integrated type).

In the above embodiment, the pillar shaped member 30c is a pillar having a constant cross-sectional shape. However, the distal end of the pillar shaped member 30c may be tapered or protruded to facilitate insertion into the cell 28.

The central axis of the core 30b does not necessarily have to coincide with the central axis X of the cell 28. The central axis of the core 30b may deviate from the central axis X of the cell 28.

Examples of the present invention will now be described. The present invention is not limited to the examples.

<Manufacture of the Honeycomb Filter>

First, 7000 wt % of alpha silicon carbide particles having an average particle diameter of 10 μm and 3000 wt % of alpha silicon carbide particles having an average particle diameter of 0.5 μm were wet blended together. Then, 570 wt % of an organic binder (methyl cellulose) and 1770 wt % of water were added to 10000 wt % of the resulting mixture, which was kneaded to prepare a mixed composition. Then, 330 wt % of a plasticizing agent (UNILUB manufactured by NOF CORPORATION) and 150 wt % of a lubricant agent (glycerin) were added to the mixed composition, which was kneaded and extruded to form a pillar-shaped molded body as shown in FIG. 3. Each cell 28 was formed to have a substantially square shape with each side being 1.165 mm and the cell wall 27 having a thickness of 0.125 mm.

Next, the molded body was dried using a microwave drier or the like to obtain a dried ceramic body. A shell 30a was filled in a peripheral region of a cell 28 and a core 30b was filled in a central region of the cell 28 to seal an open end of the cell 28. More specifically, the shells 30a and the cores 30b were formed using the plug paste prepared from the same material as the molded body. A material for changing the porosity was added to the plug paste for the shells 30a and the plug paste for the cores 30b to control the porosity of each of the shells 30a and the cores 30b. This manufactures the shells 30a and the cores 30b having the predetermined Young's moduli shown in Table 1. As a method for filling the plugs 30 into the cells 28, the pillar shaped member 30c functioning as the core 30b was first formed from the plug paste. Although the illustrated pillar shaped member 30c is a square pillar, the pillar shaped member 30c may have other shapes. The length of each side of the cross-section of the pillar shaped member 30c in each example was controlled so that the area ratio of the core 30b was 25 to 75% of the orthogonal cross-sectional plane of the cell 28 (1.165 mm×1.165 nm=1.357 mm²) as shown in Table 1. For example, to set the area ratio of the core 30b at 75%, each side of the pillar shaped member 30c was controlled to 1.009 mm. To set the area ratio of the core 30b at 50%, each side of the pillar shaped member 30c was adjusted to 0.824 mm. Afterwards, the plug paste P1 for the shells 30a was filled in the cells 28. Before the shells 30a were dried, the pillar shaped members 30c were arranged to occupy the central regions of the cells 28.

Next, the molded body was dried again using a drying apparatus, degreased at 400° C., and fired for three hours in an argon atmosphere at 2200° C. under normal pressure. This completed a honeycomb member 22 of which plugs 30 were formed by fired silicon carbide having the porosity and Young's modulus shown in Table 1. The cell walls of the fired honeycomb member 22 were formed to have a porosity of 42% and a Young's modulus value of 58.1 GPa.

To prepare a bonding agent paste for the bonding member, 30 wt % of alumina fibers having an average fiber length of 20 μm, 21 wt % of silicon carbide particles having an average particle diameter of 0.6 μm, 15 wt % of a silica zol, 5.6 wt % of carboxymethyl cellulose, and 28.4 wt % of water were kneaded. The bonding agent paste was applied to the side surface of the honeycomb fired body. Sixteen (four by four) honeycomb fired bodies were formed in the same manner and were bonded into an aggregation body. The aggregation body was then dried at 120° C. This solidified the bonding agent paste and formed a ceramic block. The thickness of the solidified bonding agent paste (bonding agent layer), that is, the interval between the adjacent honeycomb fired bodies, was 1.0 mm. Grinding was performed on the outer surface of the ceramic block with a diamond cutter to adjust the shape of the ceramic block into a cylindrical shape. A coating layer paste, formed from the same material as the material for the bonding agent paste, was used to form a coating layer having a thickness of 0.2 mm on the outer surface of the ceramic block. The coating layer was dried at 120° C. This completed the cylindrical shape honeycomb filter 21 having a diameter of 143.8 mm and a length of 150 mm, of which outer surface was coated with the coating layer.

<Regeneration Test>

The honeycomb filter 21 of each example was arranged in the exhaust gas purification device 10 to conduct an exhaust gas purification test by driving the engine at a speed of 3000 min⁻¹ and a torque of 50 Nm for a predetermined time and capturing PM. Next, the engine was driven at a speed of 4000 min⁻¹ under full load. When the temperature of the honeycomb filter 21 became constant at around 700° C., the engine speed and torque were changed to 1050 min⁻¹ and 30 Nm in order to forcibly burn the PM. In this state, the honeycomb filter 21 of each example was observed for the occurrence and enlargement of cracks near the interface between the plugs 30 and the cell walls 27.

<Estimation of Maximum Stress>

For the honeycomb filter 21 of each example prepared in the manner described above, the maximum stress generated at the interface between the plugs 30 and the cell walls 27 was estimated through a simulation (using stress simulation software “ANSYS” by ANSYS, Inc.). Table 1 and FIG. 9 show the results.

TABLE 1

| | Shell | | | Core | | | | |
|---|---|---|---|---|---|---|---|---|
| | (Peripheral Region) | | | (Central Region) | | | | |
| | | Young's | Area | | Young's | Area | Maximum | Cracks After |
| | | Modulus (E) | ratio | | Modulus (E) | Ratio | Stress | Regeneration |
| | Material | (GPa) | (%) | Material | (GPa) | (%) | (MPa) | Test |
| Example 1 | SiC | 29.1 | 25 | SiC | 58.1 | 75 | 69.6 | Not |
| | | | | | | | | Observed |
| Example 2 | SiC | 29.1 | 50 | SiC | 58.1 | 50 | 64.7 | Not |
| | | | | | | | | Observed |
| Example 3 | SiC | 29.1 | 75 | SiC | 58.1 | 25 | 61.6 | Not |
| | | | | | | | | Observed |
| Example 4 | SiC | 58.1 | 50 | SiC | 29.1 | 50 | 71.9 | Not |
| | | | | | | | | Observed |
| Comparative | — | — | 0 | SiC | 58.1 | 100 | 79.5 | Observed |
| Example 1 | | | | | | | | |
| Comparative | SiC | 29.1 | 100 | — | — | 0 | 57.3 | Observed |
| Example 2 | | | | | | | | |

As shown in Table 1 and FIG. 9, comparative example 1, which uses plugs 30 formed by pillar shaped members having a Young's modulus of 58.1 GPa, has a maximum stress of 79.5 MPa at the interface between the plugs 30 and the cell walls 27. For the honeycomb filter of comparative example 1, cracks were occurred end enlarged after the regeneration test. Comparative example 2, which uses plugs 30 formed by only the plug paste P1 for the shells 30a, has a high porosity. The plugs 30 of the honeycomb filter of comparative example 2 have a lower strength. For the honeycomb filter of comparative example 2, cracks were occurred and enlarged after the regeneration test.

Examples 1 to 4 use the plugs 30 that have a dual structure and formed by the shells 30a and the cores 30b respectively corresponding to the peripheral regions and central regions of the cells and having different Young's moduli (porosity values). The plugs 30 of examples 1 to 4 have lower maximum stress at the interface between the plugs 30 and the cell walls 27 than the honeycomb filter of comparative example 1. Further, cracks were neither occurred nor grew after the regeneration test.

A comparison between examples 2 and 4 reveals that the stress decreases as the Young's modulus of the cores 30b increases when the cores 30b have the same area ratio. A comparison of examples 1 to 3 reveals that the maximum stress decreases as the area ratio of the shells 30a having a lower Young's modulus increases.

<Evaluation of Core Shape>

Blocks 30c having cross-sectional planes orthogonal to the longitudinal direction that differ in shape were prepared. More specifically, pillar shaped members 30c having cross-sectional planes with a regular tetragonal shape, a regular orthogonal shape, and a circular shape were prepared. For these cases, the maximum stress generated at the interface between the plugs 30 and the cell walls 27 was estimated through a simulation (using stress simulation software “ANSYS” by ANSYS, Inc.). The area ratios of the shell 30a and the core 30b at the cross-sectional plane of each cell 28 were set at 50%. Table 2 shows the results.

TABLE 2

| | Shell | | | Core | | | | |
|---|---|---|---|---|---|---|---|---|
| | (Peripheral Region) | | | (Central Region) | | | | |
| | | Young's | Area | Cross- | | Young's | Area | Maximum |
| | | modulus (E) | Ratio | Sectional | | Modulus (E) | Ratio | Stress |
| | Material | (GPa) | (%) | Shape | Material | (GPa) | (%) | (MPa) |
| Example 5 | SiC | 29.1 | 50 | Tetragon | SiC | 58.1 | 50 | 64.7 |
| Example 6 | SiC | 29.1 | 50 | Octagon | SiC | 58.1 | 50 | 61.9 |
| Example 7 | SiC | 29.1 | 50 | Circle | SiC | 58.1 | 50 | 61.3 |

For a polygon, the results in Table 2 reveal that the maximum stress decreases as the number of a sides increase. Further, the maximum stress is lower when the pillar shaped member 30c has a circular cross-section than when the pillar shaped member 30c has a polygonal cross-section. Cases in which the porosity is controlled to obtain different Young's moduli are shown in this example. Although there is no data, it is considered that when using different ceramic materials to obtain different Young's moduli, substantially the same numerical results as given above are obtained.

The present examples and embodiments are to be considered as illustrative and not restrictive, and the invention is not to be limited to the details given herein, but may be modified within the scope and equivalence of the appended claims.

1. A honeycomb filter comprising:
a pillar shape honeycomb structure, which has a plurality of cells partitioned by cell walls and arranged in a honeycomb shape; and
a plug for sealing a selected one of open ends of each cell,
wherein the plug includes, in the open end of the corresponding cell, a shell that occupies a peripheral region of the corresponding cell and a core that occupies a central region of the corresponding cell, the central region including a central axis of the corresponding cell, and
wherein the core has a Young's modulus that differs from a Young's modulus of the shell.

2. The honeycomb filter according to claim 1, wherein the Young's modulus of the core is higher than the Young's modulus of the shell.

3. The honeycomb filter according to claim 1, wherein the Young's moduli are measured at about 600 to about 800° C.

4. The honeycomb filter according to claim 1, wherein the core has an area ratio of about 20 to about 80% in a cross-sectional plane orthogonal to the central axis of the corresponding cell.

5. The honeycomb filter according to claim 1, wherein the core has a substantially circular cross-sectional plane that is orthogonal to the central axis of the corresponding cell.

6. The honeycomb filter according to claim 1, wherein:
the honeycomb structure includes a plurality of first cells having a first opening cross-sectional area and a plurality of second cells having a second opening cross-sectional area that differs from the first cross-sectional area; and
either one of the plurality of first cells and the plurality of second cells are sealed by the plug including the core and the shell, and the other one of the plurality of first cells and the plurality of second cells is sealed by a plug that differs from the plug including the core and the shell.

7. The honeycomb filter according to claim 6, wherein the first opening cross-sectional area is greater than the second opening cross-sectional area, and the plug is arranged in open ends of the plurality of first cells.

8. The honeycomb filter according to claim 1, wherein:
the honeycomb structure has an upstream end through which exhaust gas enters and a downstream end from which exhaust gas is discharged; and
the plug is arranged in open ends of selected ones of the plurality of cells at the downstream end of the honeycomb structure.

9. The honeycomb filter according to claim 1, wherein:
the honeycomb structure has an upstream end through which exhaust gas enters and a downstream end from which exhaust gas is discharged; and
the plug in which the Young's modulus of the core differs from the Young's modulus of the shell is arranged at a downstream side in the cell.

10. The honeycomb filter according to claim 1, wherein:
the honeycomb structure has an upstream end through which exhaust gas enters and a downstream end from which exhaust gas is discharged; and
the plurality of cells includes cells having a large open end at the upstream end of the honeycomb structure and cells having a small open end at the downstream end of the honeycomb structure.

11. The honeycomb filter according to claim 1, wherein the plug is a ceramic plug having a dual structure in which the core and the shell are each formed of a porous ceramic.

12. The honeycomb filter according to claim 1, wherein a main material forming the shell and the core is same ceramic as a material used for the honeycomb structure.

13. The honeycomb filter according to claim 1, wherein materials forming the shell and the core each contain at least one impurity selected from the group consisting of Al, Fe, B, Si, and free carbon.

14. The honeycomb filter according to claim 1, wherein the shell and the core have mutually different porosities to have mutually different Young's moduli.

15. The honeycomb filter according to claim 14, wherein the shell and the core have porosities controlled by containing at least one selected from the group consisting of a foam material, thermoplastic resin, thermosetting resin, inorganic balloons and organic balloons with a controlled amount, or by adjusting water amount in a plug paste.

16. The honeycomb filter according to claim 1, wherein one of the shell and the core has a higher Young's modulus of about 40 to about 60 GPa, and the other has a lower Young's modulus of about 20 to about 35 GPa.

17. The honeycomb filter according to claim 1, wherein the cell walls carry a platinum group element, an alkali metal, an alkali earth metal, or an oxide thereof.

18. The honeycomb filter according to claim 1, wherein the core is formed from a pillar shaped member inserted into a shell arranged in the cell.

19. The honeycomb filter according to claim 18, wherein the pillar shaped member has a tapered or protruded distal end.

20. An exhaust gas purification device comprising:
a casing;
a honeycomb filter comprising a honeycomb structure accommodated in the casing; and
a heat insulator arranged between an inner surface of the casing and an outer surface of the honeycomb filter,
wherein the honeycomb filter includes a pillar shape honeycomb structure, which has a plurality of cells partitioned by cell walls and arranged in a honeycomb shape, and a plug for sealing a selected one of open ends of each cell,
wherein the plug includes, in the open end of the corresponding cell, a shell that occupies a peripheral region of the corresponding cell and a core that occupies a central region of the corresponding cell, the central region including a central axis of the corresponding cell, and
wherein the core has a Young's modulus that differs from a Young's modulus of the shell.

21. The exhaust gas purification device according to claim 20, wherein the Young's modulus of the core is higher than the Young's modulus of the shell.

22. The exhaust gas purification device according to claim 20, wherein the Young's moduli are measured at about 600 to about 800° C.

23. The exhaust gas purification device according to claim 20, wherein the core has an area ratio of about 20 to about 80% in a cross-sectional plane orthogonal to the central axis of the corresponding cell.

24. The exhaust gas purification device according to claim 20, wherein the core has a substantially circular cross-sectional plane that is orthogonal to the central axis of the corresponding cell.

25. The exhaust gas purification device according to claim 20, wherein:
the honeycomb structure includes a plurality of first cells having a first opening cross-sectional area and a plurality of second cells having a second opening cross-sectional area that differs from the first cross-sectional area; and
either one of the plurality of first cells and the plurality of second cells are sealed by the plug including the core and the shell, and the other one of the plurality of first cells and the plurality of second cells is sealed by a plug that differs from the plug including the core and the shell.

26. The exhaust gas purification device according to claim 25, wherein the first opening cross-sectional area is greater than the second opening cross-sectional area, and the plug is arranged in open ends of the plurality of first cells.

27. The exhaust gas purification device according to claim 20, wherein:
the honeycomb structure has an upstream end through which exhaust gas enters and a downstream end from which exhaust gas is discharged; and
the plug in which the Young's modulus of the core differs from the Young's modulus of the shell is arranged in open ends of selected ones of the plurality of cells at the downstream end of the honeycomb structure.

28. The exhaust gas purification device according to claim 20, wherein:
the honeycomb structure has an upstream end through which exhaust gas enters and a downstream end from which exhaust gas is discharged; and
the plug in which the Young's modulus of the core differs from the Young's modulus of the shell is arranged at a downstream side in the cell.

29. The exhaust gas purification device according to claim 20, wherein:
the honeycomb structure has an upstream end through which exhaust gas enters and a downstream end from which exhaust gas is discharged; and
plugs each comprising the shell and the core are arranged at either one of the upstream end and the downstream end of the honeycomb structure so that area of open cells in the upstream end of the honeycomb structure is greater than that in the downstream end.

30. The exhaust gas purification device according to claim 20, wherein a main material forming the shell and the core is same ceramic as a material used for the honeycomb structure.

31. The exhaust gas purification device according to claim 20, wherein the plug is a ceramic plug having a dual structure in which the core and the shell are each formed of a porous ceramic.

32. The exhaust gas purification device according to claim 20, wherein materials forming the shell and the core each contain at least one impurity selected from the group consisting of Al, Fe, B, Si, and free carbon.

33. The exhaust gas purification device according to claim 20, wherein the shell and the core have mutually different porosities to have mutually different Young's moduli.

34. The exhaust gas purification device according to claim 20, wherein the shell and the core have porosities controlled by containing at least one selected from the group consisting of a foam material, thermoplastic resin, thermosetting resin, inorganic balloons and organic balloons with a controlled amount, or by adjusting water amount in a plug paste.

35. The exhaust gas purification device according to claim 20, wherein one of the shell and the core has a higher Young's modulus of about 40 to about 60 GPa, and the other has a lower Young's modulus of about 20 to about 35 GPa.

36. The exhaust gas purification device according to claim 20, wherein the cell walls carry a platinum group element, an alkali metal, an alkali earth metal, or an oxide thereof.

37. The exhaust gas purification device according to claim 20, wherein the core is formed from a pillar shaped member inserted into a shell arranged in the cell.

38. The exhaust gas purification device according to claim 37, wherein the pillar shaped member has a tapered or protruded distal end.
